(19) United States
(12) Patent Application Publication
(10) Pub. No.: US 2007/0057753 A1
(43) Pub. Date: Mar. 15, 2007

(54) APPARATUS AND METHOD FOR MODIFYING PROPERTIES OF A SUBSTANCE

(76) Inventor: Shu Fen Kuo, Hsinchu City (TW)

Correspondence Address: EGBERT LAW OFFICES, 412 MAIN STREET, 7TH FLOOR, HOUSTON, TX, 77002, US

(21) Appl. No.: 11/531,480

(22) Filed: Sep. 13, 2006

(30) Foreign Application Priority Data
Sep. 14, 2005 (TW) 094131613

(51) Int. Cl. H01F 5/00

(52) U.S. Cl. 335/299

(57) ABSTRACT

An apparatus for modifying properties of a substance includes at least two electromagnetic coils and a power supply for supplying power to the two electromagnetic coils. Once powered on, the magnetic poles of the two electromagnetic coils are opposite to each other. Each coil is formed by spirally winding a plate-like wire cluster having a plurality of conductive lines, wherein the plurality of conductive lines are insulated from each other. Each of the electromagnetic coils surrounds a magnetic core that may be formed by a plurality of magnetic iron sheets, so as to facilitate the release of oscillatory waves, the conduction of magnetic lines, and the formation of the electromagnetic coils. The substance is placed in front of the direction for the magnetic lines of the magnetic field generated by the electromagnetic coils. When the electromagnetic coils are powered on, an interactive electromagnetic effect of the conductive lines is generated.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to an apparatus and a method for modifying properties of a substance, and more particularly, to an apparatus and a method for modifying properties of a substance by utilizing an electromagnetic effect.

2. Description of Related Art Including Information Disclosed Under 37 CFR 1.97 and 37 CFR 1.98.

Cigarettes and tea leaves, commonly used in a person's daily life, are enjoyed by many people. However, people worry about their health while enjoying them because nicotine in cigarettes or caffeine in tea leaves present latent risks to human health. Thus, various fiber filter tips of active carbon are added to cigarettes, or various Chinese herbal medicines, serving as absorbents or neutralizers, are added to tobacco, in order to reduce the nicotine content absorbed from the tobacco into human bodies. However, the manufacturing cost of these products increases, and the production speed is affected accordingly.

Additionally, facing the trend of a possible global energy shortage, means of effectively using petroleum products such as gasoline and machine oil for transportation is truly an important issue.

Furthermore, if skin care products are improved, then some costs can also be reduced.

In the past, electromagnetic coils have been commonly used in electric motors. Recently, electromagnetic coils have been applied in semiconductor reaction chambers to change activity, e.g., direction and intensity, of the plasma generated therein. Such further application indicates that electromagnetic coil technology has been advanced from macro-application to micro-application. However, if the technology of electromagnetic coils can be improved and further applied to molecule refinement technology and even nano-technology, these new applications will improve the quality of people's lives effectively.

### BRIEF SUMMARY OF THE INVENTION

An objective of the present invention is to provide an apparatus and a method for modifying properties of a substance for extracting desired or useful ingredients or suppressing unnecessary ingredients, thereby allowing the substances to be modified and thus enhancing efficacy.

In order to achieve the above-mentioned objective, the present invention provides an apparatus for modifying properties of a substance, which comprises at least two electromagnetic coils and a power supply for supplying power to the two electromagnetic coils. Once powered on, the magnetic poles of the two electromagnetic coils are arranged opposite to each other, i.e., the N pole of one coil faces the S pole of the other coil. Furthermore, each of the electromagnetic coils is formed by spirally winding a plate-like wire cluster having a plurality of conductive lines, wherein the plurality of conductive lines are insulated from each other. Each of the electromagnetic coils surrounds a magnetic core that can be formed by a magnetic iron block or a combination of a plurality of magnetic iron sheets (for easy dissipation of heat), so as to facilitate the release of oscillatory waves, the conduction of magnetic lines, and the formation of the electromagnetic coils.

The substance is placed in front of the magnetic lines of the magnetic field generated by the electromagnetic coils. While the electromagnetic coils are powered on, an interactive electromagnetic effect of the conductive lines is generated. The refinement processes of molecule aggregation and dispersion are performed by way of generating magnetism from electricity associated with generating electricity from magnetism and through interactive effects such as an oscillation effect generated from the interactive influence of magnetic fields, thereby achieving the substance modification.

### BRIEF DESCRIPTION OF THE SEVERAL VIEWS OF THE DRAWINGS

FIG. 1 is a perspective view of an apparatus for modifying substances according to the present invention.

FIG. 2 is a perspective view of a stereogram of an electromagnetic coil of the apparatus for modifying substances according to the present invention.

FIG. 3 is a cross-sectional view of line 1-1 in FIG. 2 according to one embodiment.

FIG. 4 is another cross-sectional view of line 1-1 in FIG. 2 according to another embodiment.

### DETAILED DESCRIPTION OF THE INVENTION

The apparatus and method of modifying properties of a substance in accordance with the present invention are described below with reference to the drawings.

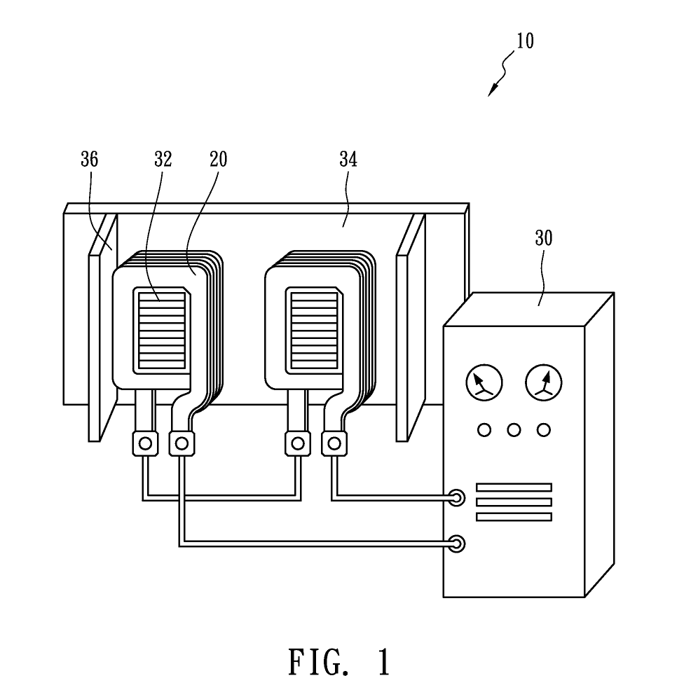

FIG. 1 is a schematic view of an apparatus for modifying a substance according to an embodiment of the present invention. The apparatus 10 for modifying properties of a substance essentially comprises two electromagnetic coils 20 and a power supply 30. The electromagnetic coils 20 are connected to the power supply 30 in series, and the power supply 30 supplies power for the electromagnetic coils 20. The electromagnetic coils 20 are attached on a plate 34 and disposed between two metal partitions 36 for enhancing the magnetic energy effect and preventing the magnetic lines from flowing out. Each of the electromagnetic coils 20 surrounds a magnetic core 32 that is formed by a plurality of magnetic iron sheets, so as to facilitate the release and heat dissipation of oscillatory waves of the electromagnetic coils 20, and the formation of the electromagnetic coils 20. In this embodiment, the power supply 30 and the electromagnetic coils 20 are connected through copper wires with a diameter of 60 mm, but other wires also can be used per requirements. The electromagnetic coils 20 spiral into the shape of a rectangle, or also can be shaped as a circle depending on design requirements.

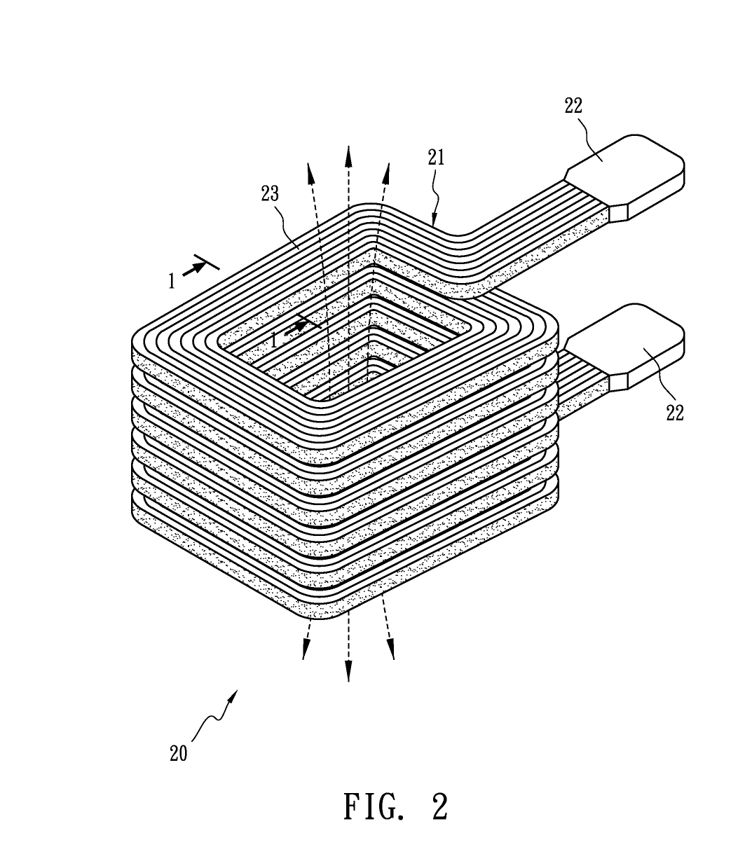

FIG. 2 is a schematic view of the electromagnetic coils 20. An electromagnetic coil 20 is formed by spiraling a plate-like wire cluster 21. The plate-like wire cluster 21, including a plurality of conductive lines 23, spirals upward and bends on the long side in terms of the cross-section thereof. The adjoining conductive lines 23 are insulated from each other. The two ends of the plate-like wire cluster 21 are connected to two electrodes 22 in order to connect to an electrical power source. The electromagnetic coil 20 generates a magnetic field approximately parallel to the forward direction of the spiral plate-like wire cluster 21 as the dotted lines shown in FIG. 2.

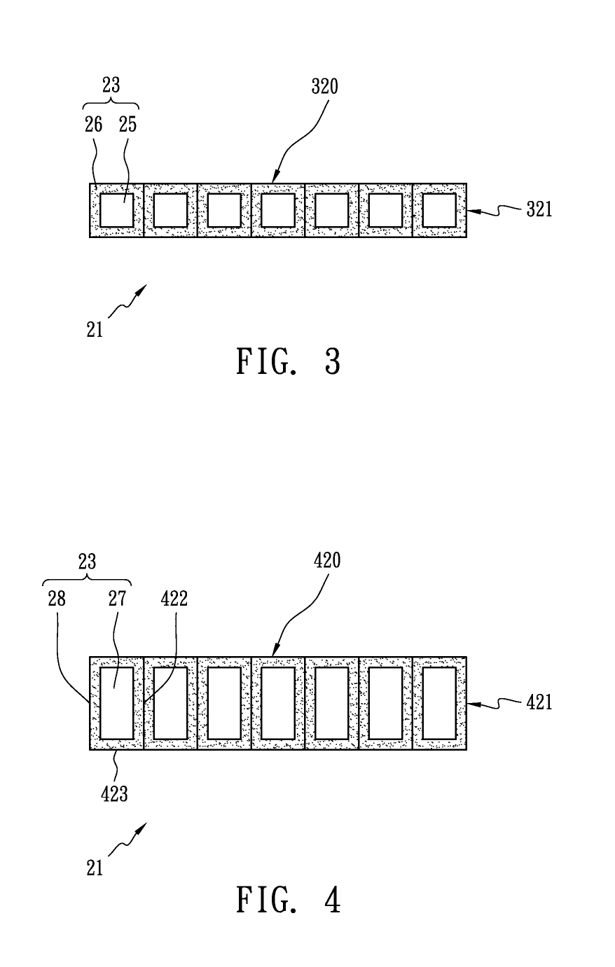

FIG. 3 illustrates the cross-sectional view of line 1-1 in FIG. 2 to show the composition of the plate-like wire cluster 21. The cross-section of the plate-like wire cluster 21 is rectangular; and the normal direction of the plane of the long side 320 is approximately parallel to the spirally forward direction of the plate-like wire cluster 21, i.e., parallel to the direction of the magnetic field generated by the electromagnetic coil 20. The short side 321 of the rectangular cross-section is approximately perpendicular to the long side 320, so that the normal direction of the plane of the short side is approximately perpendicular to the spirally forward direction of the plate-like wire cluster 21, i.e., perpendicular to the direction of the magnetic field generated by the electromagnetic coil 20.

The plate-like wire cluster 21 can be comprised of seven copper wires 25 connected in a row along the direction of the long side 320 of the cross-section of the plate-like wire cluster 21. In practice, two to fifteen copper wires 25 are preferable. Each copper wire 25 is covered by an insulation layer 26 for insulation from the adjacent one. For each copper wire 25, the cross-section is approximately square, so that manufacturing difficulties caused by a large discrepancy between inner and outer radiuses of the copper wire 25 will not occur.

FIG. 4 illustrates the cross-sectional view of another embodiment of the plate-like wire cluster 21. The plate-like wire cluster 21 comprises seven rectangular copper wires 27 disposed in a row, and the copper wires 27 are positioned vertically. Each copper wire 27 is covered by an insulation layer 28 for insulation from the adjacent one. Consequently, the long sides 422 of cross-sections of the copper wires 27 are parallel to a short side 421 of the cross-section of the plate-like wire cluster 21, and the short sides 423 of the seven copper wires 27 constitute a long side 420 of the plate-like wire cluster 21. As a result, the difference between the inner and outer radiuses of the plate-like wire cluster 21 while spiraling is minimized, thereby making manufacturing easier and decreasing residual stress as well. In this embodiment, the long side 422 of the copper wire 27 is between 4 and 6 millimeters (mm) whereas the short side 423 thereof is between 1 and 3 mm. The copper wires 25 and 27 are determined by power level requirements, and are selected accordingly.

Once powered on, the electromagnetic coils 20 in FIG. 1 generate magnetic fields with different polarities due to different current directions. If one electromagnetic coil 20 acts as an N pole, the other acts as an S pole. From a microscopic view, each of the copper wires generates a magnetic field after the electromagnetic coils 20 are powered on. Then, the generated magnetic fields further generate relevant electric fields, and such electric fields again generate magnetic fields, and so forth. Thus, the interactive influence of the electromagnet effect changes the properties of the ingredients of the substances close to the electromagnetic coils 20. Such microscopic changes are concluded to be a molecule refinement process of molecule aggregation/dispersion. In the present invention, a substance is modified by utilizing such an electromagnet effect, so as to increase desired ingredients or decrease ingredients that should be suppressed.

Additionally, the two electromagnetic coils also can be connected in parallel. As a result, the two electromagnetic coils are formed with the same polarity, which can be used for modifying a substance also.

The power supply 30 can convert an alternate current into a direct current byway of charging and discharging a capacitor. In the present embodiment, the capacity of the capacitor is set to be 65,000 μF. The voltage release of the power supply 30 is adjustable. If the voltage release is set to be 500 V, an instantaneous current value is 13,520+/−20 A. If the voltage release is set to be 400 V, the instantaneous current value is 10,770+/−20 A. If the voltage release is set to be 300 V, the instantaneous current value is 7,900+/−10 A (the current value is also influenced by the thickness of the wire). If the power supply is released by using a voltage of 500 V, a magnetic field intensity of 20000-30000 gauss is produced. A voltage of 300 V can be used to generate a magnetic field intensity of about more than 10000 gauss, and the operating time (from the power release to the generation of a magnetic field till finishing the operation) is about 1-2 seconds. In practical application, the magnetic field intensity preferably falls within a range of 10000-50000 gauss and the operation time preferably falls within a range of 1-10 seconds. However, a small coil only requires a voltage of higher than 150 V, such as 200 volt, to achieve the equivalent effect.

The distance between a test sample, i.e., a substance, and the electromagnetic coils 20 is about less than 50 cm, where the test sample is placed in front of the magnetic cores 32 of the coils or where the two magnetic fields are crossed.

Ginsengs, tea leaves, wines (58° Quemoy Sorghum Wine), gasolines, and skin care products are placed in front of the electromagnetic coils 20 to be processed as follows.

1. The ginseng: the ginseng is cut into two parts, wherein one part is processed by the electromagnetic coils according to the aforementioned method, and the other part is not processed and serves as a reference. Subsequently, 0.2 g of the ginseng is taken to be soaked in 20 ml of water of a temperature 50 for one hour. During the testing process, the ingredients of the ginseng saponin are analyzed using high performance liquid chromatograph (HPLC).

2. The tea leaves: one part of the dry tea leaves is processed by the electromagnetic coils, and the rest is not processed but serves as a reference. Subsequently, caffeine and catechin are analyzed using HPLC.

3. Unleaded gasoline #95: the gasoline to be processed by the electromagnetic coils and the gasoline not processed are both taken to be tested. A car of Nissan Cefiro 2.0 is used for the test, wherein the total displacement is 1995 c.c., the rotating speed of the engine at idle is 750 rpm, the tire pressure is 2.0 kgf/cm², and the reference weight is 1639 kg.

4. The machine oil: the machine oil to be processed by the electromagnetic coils and the machine oil not processed are both taken to be tested. X-special machine oil manufactured by China Petroleum Corporation (CPC) is employed and the temperature for the test is 23.3.

5. The collagen (a skin care product): Collagen Essence produced by Taiwan Salt Industrial Corporation is tested. Under an environment of 24, 50+/−5% RH, the water content of normal skin cutin is tested. The collagen is tested after being daubed for 60 minutes. The volunteer for the test is a female, 25-45 years old, without allergic history.

Results of the test sample before and after the electromagnetic effect are show in the table below:

| | | Average Content | Average Content |
|---|---|---|---|
| Substance | Test Item | (before process) | (after process) |
| ginseng | ginseng saponin | 3.5857 mg/g | 4.0628 mg/g |
| tea leaves | caffeine | 19.93 mg/g | 16.04 mg/g |
| tea leaves | catechin | 9.51 g/100 g | 7.32 g/mg |
| Unleaded | fuel consumption | 11.08 km/l | 11.66 km/l |
| gasoline #95 | | | |
| machine oil | viscosity | 265 cps | 247 cps |
| collagen | water content | 20.0% | 36.4% |

As known from the above test results, after the substances to be tested are modified by the substance modifying apparatus 10 of the present invention, the ingredients are obviously modified. According to the analysis of the test data, the modifications are all about the dispersion behavior of converting macromolecules within the substances into micromolecules. For example, the content of the ginseng saponin and the water content of the skin care product are increased, and the caffeine and catechin contained in the tea leaves, the consumption of the gasoline, and the viscosity of the machine oil are decreased. During the practical process of testing the machine oil, the reduction of the viscosity of the machine oil makes drivers directly feel the enhancement of horsepower, the acceleration quality, and the sensitivity of a throttle.

Additionally, after the sorghum wine is processed through an electromagnetic process by the substance modifying apparatus 10 of the present invention, tasters generally think that such wine is not acrid, less bitter, and tastes like an aged wine (aging effect). Therefore, the apparatus provided by the present invention also can be used to accelerate the aging speed of alcohols.

The above-described embodiments of the present invention are intended to be illustrative only. Numerous alternative embodiments may be devised by those skilled in the art without departing from the scope of the following claims.

I claim:

1. An apparatus for modifying properties of a substance, said apparatus comprising:
at least two electromagnetic coils, each of the electromagnetic coils being formed by spirally winding a plate-like wire cluster having a plurality of conductive lines; and
a power supply supplying power for the two electromagnetic coils;
wherein the two electromagnetic coils have an electromagnetic effect on the substance, the two electromagnetic coils generating a magnetic field with magnetic lines, said magnetic lines oriented in a direction in front of the substance, the substance being able to be modified.

2. The apparatus in accordance with claim 1, wherein the two electromagnetic coils have magnetic poles opposite to each other when the two electromagnetic coils are powered on.

3. The apparatus in accordance with claim 1, wherein said plurality of conductive lines are insulated from each other.

4. The apparatus in accordance with claim 1, wherein said plate-like wire cluster has a normal direction of a plane formed by long sides of a cross-section of said plate-like wire cluster, said plane being approximately parallel to a spirally forward direction of the plate-like wire cluster.

5. The apparatus in accordance with claim 1, wherein said plurality of conductive lines are arranged in a row along a side of a cross-section of said plate-like wire cluster.

6. The apparatus in accordance with claim 1, wherein each of the conductive lines have a rectangular cross-section.

7. The apparatus in accordance with claim 6, wherein sides of cross-sections of adjoining conductive lines are arranged in contact with each other.

8. The apparatus in accordance with claim 7, wherein said sides of the cross-sections of the conductive lines have a direction approximately parallel to the spirally forward direction of said plate-like wire cluster.

9. The apparatus in accordance with claim 1, wherein said plate-like wire cluster spirals in a shape of an approximate rectangle.

10. The apparatus in accordance with claim 1, further comprising:
two metal partitions disposed on two sides of the two electromagnetic coils.

11. The apparatus in accordance with claim 1, further comprising:
two magnetic cores surrounded by the two electromagnetic coils.

12. The apparatus in accordance with claim 1, wherein said plurality of conductive lines is comprised of 2 to 15 conductive lines.

13. The apparatus in accordance with claim 1, wherein the two electromagnetic coils are connected in series.

14. A method for modifying properties of a substance, comprising:
providing an apparatus in accordance with claim 1;
placing the substance in front of a direction of magnetic lines generated by electromagnetic coils of the apparatus; and
powering on the two electromagnetic coils to generate an electromagnet effect, so as to modify properties of the substance.

15. The method in accordance with claim 14, wherein distance between the substance and the electromagnetic coils is less than 50 cm.

16. The method in accordance with claim 14, wherein said step of powering on is comprised of applying a voltage of higher than 150 volts to the two electromagnetic coils.

17. The method in accordance with claim 14, wherein said step of powering on is comprised of applying a current of larger than 7900 amperes to the two electromagnetic coils.

18. The method in accordance with claim 14, wherein said step of powering on is comprised of generating a magnetic field having intensity within a range of 10000-50000 gauss.

19. The method in accordance with claim 14, wherein said step of powering on is comprised of taking time to supply power to the two electromagnetic coils within a range of 1-10 seconds.

20. The method in accordance with claim 14, wherein the substance is selected from the group consisting of ginsengs, tea leaves, gasolines, machine oils, alcohols, and skin care products.

21. The method in accordance with claim 20, wherein modified ingredients of the substance include ginseng saponin, caffeine, and catechin.
